(19) United States
(12) Patent Application Publication
(10) Pub. No.: US 2026/0336975 A1
(43) Pub. Date: Oct. 29, 2026

(54) SAFETY SWITCH FAULT LOCATION UNIT FOR ELEVATORS, SAFETY SWITCH FAULT LOCATION SYSTEM, AND ELEVATOR SYSTEM

(71) Applicant: Otis Elevator Company, Farmington, CT (US)

(72) Inventor: Hongliang Tian, Shanghai (CN)

(21) Appl. No.: 19/410,464

(22) Filed: Dec. 5, 2025

(30) Foreign Application Priority Data
Apr. 29, 2025 (CN) 202510565055.5

(51) Int. Cl. B66B 5/02; B66B 5/00

(52) U.S. Cl. CPC B66B 5/02; B66B 5/0031

(57) ABSTRACT

A safety switch fault locating unit for an elevator, wherein a plurality of safety switches of the elevator are connected in series to form a safety chain, the fault locating unit including: an input terminal and an output terminal, for electrically connecting the fault locating unit to the safety chain so that the fault locating unit is connected in parallel with at least one safety switch in the safety chain; a fault indicating module, for sending an indication signal; and a controlling module, electrically connected to the fault indicating module and configured to control the fault indicating module to send the indication signal when at least one safety switch is faulty.

### FOREIGN PRIORITY

This application claims priority to Chinese Patent Application No. 202510565055.5, filed Apr. 29, 2025, and all the benefits accruing therefrom under 35 U.S.C. § 119, the contents of which in its entirety are herein incorporated by reference.

### TECHNICAL FIELD

The present disclosure relates to the technology of elevators, in particular to the technology of safety switch fault location of an elevator.

### BACKGROUND

When an elevator landing door lock is faulty, the maintenance personnel need to inspect each floor to determine which specific landing the fault has occurred on.

### SUMMARY

The present disclosure provides a safety switch fault locating unit for an elevator to at least reduce the workload of fault inspection. In a safety switch fault locating unit for an elevator according to the examples of the present disclosure, a plurality of safety switches of the elevator are connected in series to form a safety chain. The fault locating unit may comprise: an input terminal and an output terminal, for electrically connecting the fault locating unit to the safety chain so that the fault locating unit is connected in parallel with at least one of the plurality of safety switches on the safety chain; a fault indicating module, for sending an indication signal; a controlling module, electrically connected to the fault indicating module and configured to control the fault indicating module to send the indication signal when the at least one safety switch is faulty.

Optionally or additionally, in the safety switch fault locating unit, the controlling module may comprise: an adjustment circuit, for adjusting a voltage applied to the fault locating unit through the input terminal and the output terminal by the safety chain to a voltage suitable for the operation of the fault indicating module when at least one safety switch is faulty, so that the fault indicating module sends an indication signal.

Optionally or additionally, in the safety switch fault locating unit, the adjustment circuit may comprise: a first circuit, connected to the output terminal and comprising at least a resistor, wherein the first circuit is configured to output a signal that causes the fault indicating module to operate when the at least one safety switch is faulty; a second circuit, for receiving a signal output from the first circuit and comprising at least a switching device, wherein the switching device turns on to enable the fault indicating module to send an indication signal when the signal received is a signal that causes the fault indicating module to operate.

Optionally or additionally, in the safety switch fault locating unit, the first circuit further comprises an optocoupler element comprising a diode and a phototransistor, wherein the diode enters a non-conducting state when the at least one safety switch is faulty, causing the phototransistor to turn off; the second circuit comprises a voltage divider circuit and a switching device, wherein a control terminal of the switching device is connected to an output terminal of the phototransistor at a connection point located in the voltage divider circuit, where when the phototransistor turns off, the switching device turns on, causing the fault indicating module connected to the switching device to enter an operating state.

Optionally or additionally, in the safety switch fault locating unit, the switching device is one of the following devices: a transistor, a relay.

Optionally or additionally, in the safety switch fault locating unit, the safety switches are landing door safety switches, and the safety chain is formed by connecting the landing door safety switches in series.

Optionally or additionally, in the safety switch fault locating unit, the input terminal and the output terminal of the fault locating unit are both constructed as terminals electrically connected to the safety chain in a removable manner.

Optionally or additionally, in the safety switch fault locating unit, the fault indicating module is one or more of the following: a light indicator, a buzzer. As an example, the light indicator is a light-emitting diode.

According to another aspect of the present disclosure, a safety switch fault location system for an elevator is also provided, wherein a plurality of safety switches of the elevator are connected in series to form a safety chain, and the fault location system comprises a plurality of fault locating units connected to the safety chain, where each of the fault locating units is any one of the safety switch fault locating units described herein.

Optionally or additionally, the safety switch fault location system further comprises a master switch connected in series at the end of the safety chain, so as to cut off the safety chain through the master switch when needed.

Optionally or additionally, in the safety switch fault location system, the fault locating units are arranged corresponding to the landings.

An elevator system is also provided, comprising any one of the safety switch fault locating units described herein or any one of the safety switch fault location systems described herein.

### BRIEF DESCRIPTION OF THE DRAWINGS

The present disclosure can be fully understood by referring to the detailed description of the specific embodiments below in conjunction with the accompanying drawings, where:

FIG. 1 schematically depicts an elevator 2;

FIG. 2 illustrates the structure of a safety switch fault locating unit 30 according to some embodiments of the present disclosure;

FIG. 3 is a structural schematic diagram of a safety switch fault location system for an elevator according to some embodiments of the present disclosure;

FIG. 4 is a schematic structure of a safety switch fault location system according to further embodiments of the present disclosure;

FIG. 5 illustrates a fault locating unit.

### DETAILED DESCRIPTION OF THE INVENTION

To assist those skilled in the art to gain a precise understanding of the subject matter claimed by the present disclosure, the specific embodiments of the present disclosure will be described in detail below in conjunction with the accompanying drawings.

The terms “example”, “as an example”, or “illustratively”, used in the following text mean “used as an example, embodiment, or illustration”. Any embodiment depicted as an “example”, or “as an example” or “illustratively” need not be interpreted as being superior or better than other embodiments.

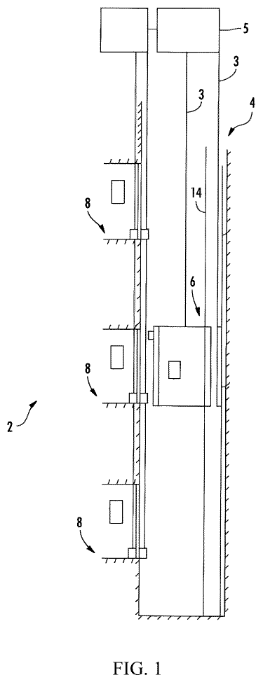

FIG. 1 schematically depicts an elevator 2. The elevator 2 comprises an elevator car 6 arranged in a movable manner within a hoistway 4 extending between a plurality of landings 8. The elevator car 6 is movable along a plurality of car guide members 14, such as guide rails, extending along the vertical direction of the hoistway 4. Only one of said car guide members 14 is visible in FIG. 1. Although only one elevator car 6 is depicted in FIG. 1, it should be appreciated that the exemplary embodiments of the present disclosure may include elevators 2 having a plurality of elevator cars 6 moving in one or more hoistways 4. The elevator car 6 is movable suspended by means of a tension member 3. The tension member 3, for example a rope or belt, is connected to a drive unit 5, which is configured for driving the tension member 3 in order to move the elevator car 6 along the hoistway 4 between the plurality of landings 8 located on different floors. Each landing 8 is provided with a landing door (not identified) and the elevator car 6 is provided with a corresponding elevator car entrance for allowing passengers to transfer between a landing 8 and the interior of the elevator car 6 when the elevator car 6 is positioned at the respective landing 8.

It should be appreciated that FIG. 1 only illustrates part of an elevator structure, while a controller of the elevator control system, as well as other structures, modules, members, components and connection relationships, are not illustrated.

In the specific examples described hereinafter in conjunction with the accompanying drawings in the present disclosure, the safety chain is a safety circuit formed by connecting safety switches of a plurality of landing doors of an elevator in series, which is only illustrative but not restrictive.

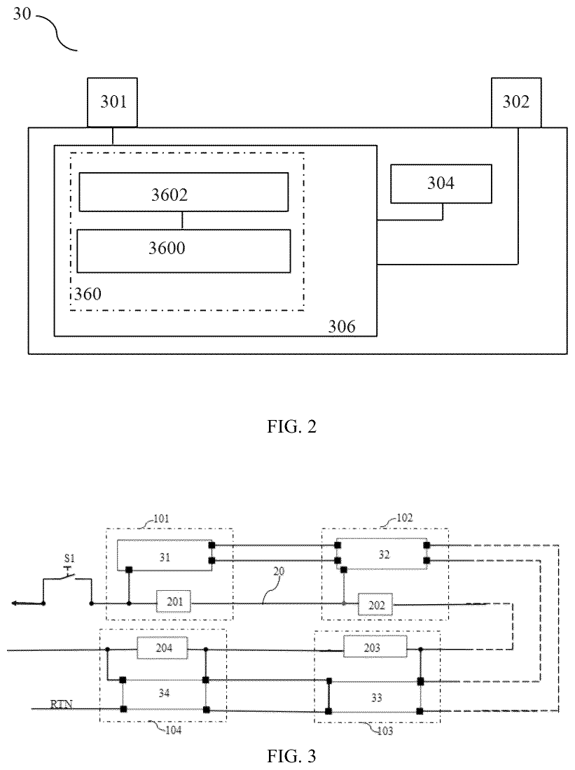

FIG. 2 illustrates the structure of a safety switch fault locating unit 30 according to some embodiments of the present disclosure. As shown in FIG. 2, the fault locating unit 30 comprises two connection terminals, namely an input terminal 301 and an output terminal 302. The fault locating unit 30 is electrically connected to the safety chain through the input terminal 301 and the output terminal 302, and is connected in parallel with at least one safety switch on the safety chain.

In some examples, one fault locating unit is connected in parallel with one safety switch in the safety chain. In other examples, one fault locating unit is connected in parallel with a plurality of safety switches in the safety chain. In the examples described hereinafter with reference to the accompanying drawings, one fault locating unit is connected in parallel with one or more safety switches provided for one landing door on the safety chain. In other words, the fault locating unit corresponds one-to-one with the landing door. It should be noted that one safety switch or more than one safety switches can be provided for one landing door. For example, in a specific example, a landing door is provided with three safety switches.

Referring to FIG. 2, the fault locating unit 30 can include a fault indicating module 304 and a controlling module 306 electrically connected to the fault indicating module 304. The fault indicating module 304 is used for sending an indication signal. It can be a device that sends an indication signal in a visible form, such as a light-emitting diode, or a device that sends an indication signal in an audible form, such as a buzzer, or a device that sends an indication signal in a tactile form, such as an oscillating device, or any combination of the above. The controlling module 306 is used for enabling the fault indicating module 304 to output an indication signal when at least one safety switch is faulty.

As an example without limitation, the fault indicating module 304 in various embodiments of the present disclosure employs a light-emitting diode (LED). Therefore, when the LED lights up, it is outputting the indication signal. The controlling module 306 can be implemented via a circuit. Specifically, the controlling module 306 may comprise an adjustment circuit 360, which adjusts the voltage applied to the fault locating unit via the input terminal 301 and the output terminal 302 of the safety chain to a level suitable for the operation of the fault indicating module 304 when at least one safety switch is faulty such that the fault indicating module 304 sends out an indication signal. As an example, the adjustment circuit can comprise a first circuit 3600 and a second circuit 3602. The first circuit 3600 is connected to the output terminal 302. The first circuit 3600 comprises at least a resistor, and is configured to output, when the at least one safety switch is faulty, a signal which can cause the fault indicating module to operate. The second circuit 3602 receives the signal output from the first circuit 3600. The second circuit 3602 comprises at least a switching device. The switching device turns on when the received signal is the signal that causes the fault indicating module 304 to operate, to make the fault indicating module 304 send an indication signal.

As an example, the first circuit 3600 further comprises an optocoupler element comprising a diode and a phototransistor. The diode enters a non-conducting state when the at least one safety switch is faulty, causing the phototransistor to turn off. As an example, the second circuit 3602 comprises a voltage divider circuit and the switching device. The control terminal of the switching device is connected to the output terminal of the phototransistor, and the connection point is located in the voltage divider circuit. When the phototransistor turns off, the switching device conducts, causing the fault indicating module 304 connected to the switching device to enter an operating state. The switching device can be one of the following devices: a transistor, a relay. Transistors can employ, for example, one of bipolar transistors, field-effect transistors, insulated gate bipolar transistors, and the like.

FIG. 3 illustrates a block diagram of a safety switch fault locating system for an elevator according to some embodiments of the present disclosure. For the sake of brevity, FIG. 3 illustrates four landings, namely landing 101, landing 102, landing 103, and landing 104. The specific number of landings is related to the number of floors in the building where the elevator is installed. For example, when the building is an n-story building, it can include n landings. The dashed lines in FIG. 3 indicate that more landings may be included or that some landings may be omitted.

Corresponding to the landings, FIG. 3 illustrates the safety switches in the safety chain 20, including a safety switch 201 of a landing door at landing 101, a safety switch 202 of a landing door at landing 102, a safety switch 203 of a landing door at landing 103, and a safety switch 204 of a landing door at landing 104. According to the examples of the present disclosure, the safety switch fault locating system comprises a plurality of fault locating units. In some cases, one fault locating unit corresponds to two or more landings, and in some cases, one fault locating unit corresponds to one landing. In this example, one fault locating unit corresponds to one landing. As shown in FIG. 3, the fault locating unit 31 is connected to the safety chain 20 in parallel with the safety switch 201 of the landing door at landing 101, the fault locating unit 32 is connected to the safety chain 20 in parallel with the safety switch 202 of the landing door at landing 102, a fault locating unit 33 is connected to the safety chain 20 in parallel with the safety switch 203 of the landing door at landing 103, and a fault locating unit 34 is connected to the safety chain 20 in parallel with the safety switch 204 of the landing door at landing 104. As an example, each fault locating unit in the system shown in FIG. 3 can employ the fault locating unit described above with reference to FIG. 2.

As shown in FIG. 3, for the safety switch fault locating system, all safety switches are closed and the safety chain 20 is closed when the elevator is running normally. When the safety switch of a certain landing door in the safety chain disconnects, the controlling module of the fault locating unit connected in parallel with the safety switch of this landing door control the fault indicating module to output an indication signal. Specifically, during normal operation of the elevator, the voltage of the fault locating unit is insufficient to cause the fault indicating module to operate. When the safety switch connected in parallel with the fault locating unit turns off, the voltage of the fault locating unit changes, causing the voltage of the fault indicating module to reach the operating voltage, and an indication signal is thus sent.

For example, in FIG. 3, the current in the electrical circuit of the safety chain 20 flows from the safety switch of the landing door at landing 104 to the safety switch of the landing door at landing 101. When the safety chain 20 disconnects due to the disconnection of the safety switch 202 at landing 102, there is still voltage (e.g., 30V) on both sides of the safety switches 204 and 203 of the landing doors at landings 104 and 103. However, the input terminal voltage of the fault locating unit 32 connected in parallel with the safety switch 202 is still 30V and the output terminal voltage thereof changes to 0V. At this point, the fault locating unit according to the example of the present disclosure will control the fault indication unit to output an indication signal due to the voltage change.

It can thus be seen that when an elevator employs the safety switch fault locating system according to the examples of the present disclosure, once the safety chain is disconnected due to a safety switch being disconnected or due to failure, the fault indicating light of the fault locating unit connected in parallel with the turn-off safety switch will send an indication signal, thereby pinpointing at which landing the safety switch has disconnected. In some examples, a light-emitting diode, as the fault indicator light, sends out an indication signal by lighting up, allowing maintenance personnel to easily identify which floor's corresponding safety switch is open based on this signal.

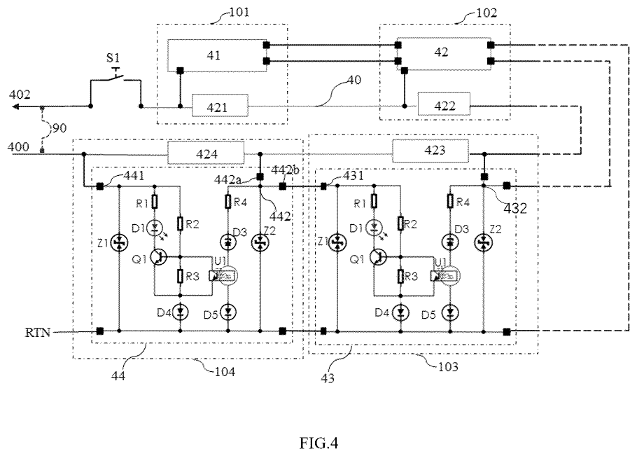

Furthermore, according to an example of the present disclosure, a master switch S1 is connected in series in the safety chain. Specifically, the master switch S1, which can be a manual switch, is located at the end of the safety circuit formed by the safety chain and is connected in series with safety switches. When the elevator is running normally, the master switch S1 should be in the turn-on state. However, in case of the safety chain being disconnected, the master switch S1 needs to be turned off if it is necessary to identify the faulty safety switch by activating a Door Switch Bypass Device (DSBD). It should be appreciated that when the fault indicating module is installed in a location that is usually not visible, such as within a hoistway, the fault indicator light may not be easily visible even after the safety chain is disconnected. To this end, according to embodiments of the present disclosure, the master switch S1 is provided such that the maintenance personnel can determine the faulty safety switch by performing the following operations: activating the Door Switch Bypass Device (DSBD) in the control room, thereby enabling the elevator to operate in a temporary operation mode for maintenance, manually opening the landing door, and boarding the car. According to some examples of the present disclosure, while activating the DSBD and simultaneously setting the master switch S1 to the turn-off state, the fault indicating module of the fault locating unit corresponding to the landing door, where the landing door safety switch is faulty, is caused to send an indication signal, which can be quickly detected by the maintenance personnel in the hoistway. Sequential checking of each landing is thus unnecessary. Further details of this process will be described below in conjunction with the example of FIG. 4.

FIG. 4 is a schematic configuration of a safety switch fault locating system according to a further embodiment of the present disclosure. Similar to the embodiment shown in FIG. 3, four landings are shown in this example, including landing 101, landing 102, landing 103, and landing 104. The fault locating units are arranged in a one-to-one correspondence with the landings. In this example, the safety switch of the landing door at each landing in the safety chain 40 is, for example, the landing door switch of that landing. Compared with FIG. 3, the example in FIG. 4 will describe, referring to one fault locating unit, details of the structure and working principle of the fault locating unit.

Referring to FIG. 4, the current of the safety chain 40 flows from the input terminal 400 of the safety chain to the output terminal 402 of the safety chain, and after exiting through the output terminal 402, the current enters the return path, and finally returns to the elevator control system from the return terminal (RTN), thus forming a complete electrical circuit. When the safety chain 40 fails, for example any of the safety switches is broken or turned off, the entire safety circuit is turned off, thus triggering the safety braking mechanism of the elevator control system and causing the elevator to stop running to ensure passenger safety. In this example, the master switch S1, which is, for example, a manual switch, is arranged at the output terminal 402 of the safety chain 40, specifically at the end of the safety chain 40.

In this example, the fault locating units are arranged in a one-to-one correspondence with the landings. Specifically, the fault locating unit 44 is electrically connected to the safety chain 40 via the input terminal 441 and the output terminal 442 thereof, so as to be connected in parallel with the safety switch 424 of the landing door at landing 104. The fault locating unit 43 is electrically connected to the safety chain 40 via the input terminal 431 and the output terminal 432 thereof, so as to be connected in parallel with the safety switch 423 of the landing door at landing 103. Similarly, the fault locating unit 42 is electrically connected to the safety chain 40 and connected in parallel with the safety switch 422 of the landing door at landing 102, and the fault locating unit 41 is electrically connected to the safety chain 40 and connected in parallel with the safety switch 421 of the landing door at landing 101.

According to this example, the input terminal and the output terminal for connecting to the safety chain of each fault locating unit can be configured as terminals that can be electrically connected to the safety chain in a removable manner. For example, the input terminal and the output terminal can be configured as clip-on terminals to facilitate the operating personnel to easily and quickly connect the fault locating unit to the safety chain through the clip-on terminals. Furthermore, the output terminal of each fault locating unit comprises two sub-ports, where one of the ports is connected to the safety chain and the other is connected to the adjacent fault locating unit. For example, in this example, the input terminal 441 of the fault locating unit 44 is electrically connected to the safety chain 40, and the output terminal 442 comprises two sub-ports 442a and 442b, where the sub-port 442a is electrically connected to the safety chain 40 and the sub-port 442b is electrically connected to the input terminal 431 of the fault locating unit 43.

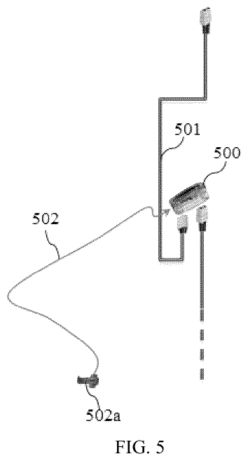

In some examples, each fault locating unit is implemented in a box. That is to say, the fault indicating module and the controlling module are arranged inside a box. When the fault indicating module is a light-emitting diode, the box is at least partially transparent so that the light is visible. Further, the box can be configured with a wiring port for connecting a cable, and the other end of the cable can be configured as connecting to the safety chain in a removable manner. FIG. 5 illustrates one such fault locating unit. As shown in FIG. 5, the fault indicating module and the controlling are arranged inside the box 500, and the terminals of the box can be configured, for example, as the wire 501, wire 502, or a combination thereof, where the port of wire 501 can be plugged into other components, while the port 502a of wire 502 is a clamp that can be clamped onto, for example, the safety chain.

Reference is made to the fault locating unit 43 in FIG. 4. In this example, the fault indicating module is a LED D1, which is electrically connected to the controlling module. In this specific example, the anode of the LED D1 can be connected to the input terminal 431 of the fault locating unit 43 through a current-limiting resistor R1. The current-limiting protection resistor R1 serves to limit the current passing through the LED D1, preventing excessive current from damaging D1. In a specific example, the controlling is implemented as an adjustment circuit including a first circuit and a second circuit. Specifically, the first circuit comprises a resistor R4, a Zener diode D3, and an optocoupler U1. The optocoupler U1 includes an LED and a phototransistor, in which the phototransistor conducts when the LED illuminates as the current flows through it, and does not conduct when the LED does not illuminate as no current flows through it. The second circuit comprises a voltage divider circuit and a transistor Q1, in which the voltage divider circuit includes voltage divider resistors R2 and R3, and the transistor Q1 is used as a switching device. The base of the transistor Q1 is connected to the collector of the phototransistor of the optocoupler U1, and the emitter of the transistor Q1 is connected to the emitter of the phototransistor of the optocoupler U1, in which both the connection points are located in the voltage divider circuit. Diodes D4 and D5 each are provided to ensure current flows in a specific direction in their respective current circuits, playing a role in level control while preventing reverse current interference in the circuit. The first circuit and the second circuit are connected to the return terminal (RTN) of the safety chain through diode D5 and diode D4, respectively. The varistor Z1, arranged between the input terminal 431 and the return terminal (RTN), and the varistor Z2, connected between the output terminal 432 and the return terminal (RTN) of the safety chain, can provide overvoltage protection to suppress transient overvoltages in the voltage adjustment circuit. When an excessive voltage surge occurs in the circuit, the value of the varistors will change rapidly, diverting the overvoltage to the return terminal (RTN). The configuration of other fault locating units can be identical to that of the fault locating unit 43, and thus will not be elaborated further.

In the system shown in FIG. 4, when all the safety switches in the safety chain 40 are closed, the safety chain 40 is closed. At this time, the voltage of the second circuit in each fault locating unit is at its normal level, and the LED of the optocoupler U1 conducts, which in turn activates the phototransistor. The transistor Q1, whose base is connected between the voltage divider resistors R2 and R3, is caused to cut off. As a result the LED D1 is turned off and cannot emit light. In the event that a safety switch at any landing door fails, causing the safety chain to disconnect, the voltage of the second circuit of the fault locating unit connected in parallel with that specific landing door's safety switch drops. This reduced voltage drops below the conduction voltage of the Zener diode D3, preventing the optocoupler U1 from conducting, thereby causing the LED D1 in the first circuit to turn on and emit light. For example, when the safety switch 423 fails, the input terminal 431 of the fault locating unit 43 remains at a high voltage because it is located upstream in the safety chain circuit. In contrast, the voltage at the output terminal 432 drops to 0V, and the voltage of the return terminal (RTN) is 0V. At this point, since the voltage at the output terminal 432 is 0V, it cannot forward-bias the LED of the optocoupler U1. As a result, the phototransistor of the optocoupler U1 cuts off, which causes the transistor Q1, whose base is connected between the voltage divider resistors R2 and R3, to turn on. Consequently, the LED D1, which serves as the fault indicating module, lights up, thereby indicating that the landing door lock at landing 103 is faulty.

The following will further illustrate how the elevator system employing the exemplary system herein, after a safety chain breakage, utilizes the fault locating units to identify the floor where a safety switch has opened during the DSBD check and maintenance process. The fault indicating modules are typically installed within the hoistway. Therefore, it may be necessary to identify the fault indicating module that sends the indication signal using the process described below. With reference to FIG. 4, after the safety chain 40 is disconnected, the maintenance personnel first open the master switch S1 and activate the Door Switch Bypass Device (DSBD) 90 (e.g., by inserting the DSBD plug in the control room), so as to short-circuit safety switches and enable the slow-speed operation mode of the elevator. In this way, the maintenance personnel can manually open the landing door, board the elevator car, and carry out maintenance on the elevator. Furthermore, since the master switch S1 has opened in the safety chain, the safety chain 40 is in an open state. At this point, the safety switch 424 located upstream in the safety chain is in its normal closed state, and thus the LED D1 in the fault locating unit 44 remains off. The safety switch 423 is the faulty, open safety switch, and, as described above, the LED D1 in the fault locating unit 43 illuminates. Accordingly, the maintenance personnel can identify the failed door lock and pinpoint the specific landing door switch that is open by observing that LED D1 is lit. The maintenance personnel can then repair the door lock. After resolving the issue of the door lock being open, they deactivate the DSBD and close the master switch S1 to allow the elevator to operate normally. In the present disclosure, the upstream in the safety chain is defined by the direction of current flow in the safety chain's current loop. For example, in the current loop of the safety chain 40, current flows from the input terminal 400 of the safety chain to the output terminal 402 of the safety chain. Therefore, in FIG. 4, the safety switch 424 is located upstream of the safety switch 423 and other safety switches, and the safety switch 423 is located upstream of the safety switch 422 and other safety switches, and so on.

For an elevator system that does not employ the fault locating unit or fault location system according to the embodiments of the present disclosure, when a safety switch such as a landing door switch is abnormal, the maintenance personnel can only check the landing door switches one by one on site. However, in an elevator system that is equipped with the fault locating unit or fault location system according to the embodiments of the present disclosure, when an abnormality occurs in a safety switch such as a landing door switch, the maintenance personnel can determine which landing the open safety switch is located on by visually checking the illumination of the fault indicating modules (e.g., LED D1) in the fault locating units provided for the landing door switches during on-site maintenance, thus greatly accelerating fault identification and greatly simplifying the required inspection procedures.

According to some embodiments, an elevator system is also provided. The elevator system may include a safety switch fault locating unit or a safety switch fault locating system according to any of the embodiments above.

Although specific embodiments of the present disclosure have been shown and described in detail to illustrate the principle of the present disclosure, it should be understood, however, that the present disclosure may be implemented in other ways without departing from such principle, such as by combining the features of the embodiments described herein to obtain new embodiments.

What is claimed is:

1. A safety switch fault locating unit for an elevator, where a plurality of safety switches of the elevator are connected in series to form a safety chain, the fault locating unit comprising:
an input terminal and an output terminal, for electrically connecting the fault locating unit to the safety chain so that the fault locating unit is connected in parallel with at least one of the plurality of safety switches in the safety chain;
a fault indicating module, for sending an indication signal; and
a controlling module, electrically connected to the fault indicating module and configured to control the fault indicating module to send the indication signal when the at least one of the safety switches is faulty.

2. The safety switch fault locating unit according to claim 1, wherein the controlling module comprises:
an adjustment circuit, for adjusting a voltage applied to the fault locating unit through the input terminal and the output terminal by the safety chain to a voltage suitable for operation of the fault indicating module when the at least one safety switch is faulty, so that the fault indicating module sends an indication signal.

3. The safety switch fault locating unit according to claim 2, wherein the adjustment circuit further comprises:
a first circuit connected to the output terminal, comprising at least a resistor, wherein the first circuit is configured to output a signal that causes the fault indicating module to operate when the at least one safety switch is faulty; and
a second circuit, for receiving signals output by the first circuit and comprising at least a switching device, wherein the switching device turns on to enable the fault indicating module to send an indication signal when receiving a signal that triggers the fault indicating module to operate.

4. The safety switch fault locating unit according to claim 3, wherein the first circuit further comprises an optocoupler element comprising a diode and a phototransistor, wherein the diode enters a non-conducting state when the at least one safety switch is faulty, causing the phototransistor to turn off; and
the second circuit comprises a voltage divider circuit and a switching device, wherein a control terminal of the switching device is connected to an output terminal of the phototransistor at a connection point located in the voltage divider circuit, where the switching device turns on when the phototransistor turns off, causing the fault indicating module connected to the switching device to enter an operating state.

5. The safety switch fault locating unit according to claim 3, wherein the switching device is one of the following devices: a transistor, a relay.

6. The safety switch fault locating unit according to claim 1, wherein the plurality of safety switches are landing door safety switches, and the safety chain is formed by connecting the plurality of the landing door safety switches in series.

7. The safety switch fault locating unit according to claim 1, wherein the input terminal and the output terminal of the fault locating unit are both constructed as terminals that are electrically connected to the safety chain in a removable manner.

8. The safety switch fault locating unit according to claim 1, wherein the fault indicating module is one or more of the following: a light indicator, a buzzer.

9. The safety switch fault locating unit according to claim 8, wherein the light indicator is a light-emitting diode.

10. A safety switch fault locating system for an elevator, a plurality of safety switches of the elevator being connected in series to form a safety chain, wherein the fault locating system comprises:
a plurality of fault locating units connected to the safety chain, wherein each of the fault locating units is a safety switch fault locating unit according to claim 1.

11. The safety switch fault location system according to claim 10, wherein the fault locating system further comprises a master switch connected in series at the end of the safety chain.

12. The safety switch fault location system according to claim 10, wherein the fault locating units are arranged corresponding to landings.

13. An elevator system, wherein the elevator system comprises a safety switch fault locating unit according to claim 1.
